(19) United States
(12) Patent Application Publication
(10) Pub. No.: US 2024/0054412 A1
(43) Pub. Date: Feb. 15, 2024

(54) METHOD AND SYSTEM FOR GENERATING VEHICLE ROUTES

(71) Applicant: GRABTAXI HOLDINGS PTE. LTD., Singapore (SG)

(72) Inventors: Yibo JI, Singapore (SG); Jun Jie Larry LIN, Singapore (SG)

(21) Appl. No.: 18/260,869

(22) PCT Filed: Apr. 27, 2022
(86) PCT No.: PCT/SG2022/050250

§ 371 Date: Jul. 10, 2023

(30) Foreign Application Priority Data
May 5, 2021 (SG) 10202104668R

(51) Int. Cl. G06Q 10/047; G06Q 50/30; G06Q 10/02

(52) U.S. Cl. CPC G06Q 10/047; G06Q 50/30; G06Q 10/025

(57) ABSTRACT

Method and system for generating vehicle routes, the method including: obtaining a plurality of bookings including pick-up and drop-off location; estimating, for each combination of two bookings, a groupability by determining a cost ratio of the combination as a ratio of the cost of the combination to the sum of the cost of the two bookings taken separately, wherein a higher groupability represents a lower cost ratio, and a lower groupability represents a higher cost ratio; identifying, based on the groupability, all bookings that may not be groupable to any other booking of the plurality of bookings, as ungroupable bookings; identifying, based on the groupability, all bookings that may be groupable to at least one other booking of the plurality of bookings, as groupable bookings; determining a vehicle route by applying a vehicle routing problem solver on the groupable bookings; and adding the ungroupable bookings to the vehicle route.

### TECHNICAL FIELD

An aspect of the disclosure relates to a method for generating vehicle routes. Another aspect of the disclosure relates to a data processing system for generating vehicle routes. Another aspect of the disclosure relates to a non-transitory computer-readable medium storing computer executable code.

### BACKGROUND

The vehicle routing problem (VRP) is one of the most-researched and practically relevant problems in combinatorial optimization. The goal of solving VRPs may be, e.g., to design least cost routes that transport bookings from their pick-ups to drop-offs subject to a set of constraints. VRP solvers are applied in product delivery systems (such as grocery delivery) and car hailing, e.g., for passenger transportation. Exact mathematical optimization approaches can find optimal solutions for small-size problems, but as the problem size and complexity increases, they cannot return high-quality solutions within reasonable time. Therefore, there remains a need to provide for an efficient method for generating vehicle routes.

### SUMMARY

An aspect of the disclosure relates to a method for generating vehicle routes. The method may include obtaining a plurality of bookings, each booking of the plurality of bookings including a pick-up and a drop-off location. The method may include estimating, for each combination of two bookings of the plurality of bookings, a groupability by determining a cost ratio of the combination as a ratio of the cost of the combination to the sum of the cost of the two bookings taken separately. A higher groupability may represent a lower cost ratio, and a lower groupability may represent a higher cost ratio. The method may further include identifying, based on the groupability, all bookings that may be not groupable to any other booking of the plurality of bookings, as ungroupable bookings. The method may further include identifying, based on the groupability, all bookings that may be groupable to at least one other booking of the plurality of bookings, as groupable bookings. The method may further include determining a vehicle route by applying a vehicle routing problem solver on the groupable bookings. The method may further include adding the ungroupable bookings to the vehicle route. The method is a computer-implemented method, and may be implemented on a computer, a computer system, a distributed system and/or a cloud system.

An aspect of the disclosure relates to a data processing system for generating vehicle routes. The system may include a computer including a microprocessor and a memory, wherein the memory may be configured to be accessed by the microprocessor. The system may include a communication interface configured to obtain a plurality of bookings, each booking of the plurality of bookings including a pick-up and a drop-off location. The computer may be configured to estimate, for each combination of two bookings of the plurality of bookings, a groupability by determining a cost ratio of the combination as a ratio of the cost of the combination to the sum of the cost of the two bookings taken separately. A higher groupability may represent a lower cost ratio, and a lower groupability may represent a higher cost ratio. The computer may be further configured to identify, based on the groupability, all bookings that may be not groupable to any other booking of the plurality of bookings, as ungroupable bookings. The computer may be further configured to identify, based on the groupability, all bookings that may be groupable to at least one other booking of the plurality of bookings, as groupable bookings. The computer may be further configured to determine a vehicle route by applying a vehicle routing problem solver on the groupable bookings. The computer may be further configured to add the ungroupable bookings to the vehicle route. The computer may be further configured to store the vehicle route in the memory.

An aspect of the disclosure relates to a non-transitory computer-readable medium storing computer executable code including instructions for generating vehicle routes according to the method described herein in accordance with various embodiments.

An aspect of the disclosure relates to a computer executable code including instructions for generating vehicle routes according to the method described herein in accordance with various embodiments.

### BRIEF DESCRIPTION OF THE DRAWINGS

The invention will be better understood with reference to the detailed description when considered in conjunction with the non-limiting examples and the accompanying drawings, in which:

FIG. 1 shows an exemplary and non-limiting flowchart of a method 100 used as illustration to explain embodiments of the present disclosure;

FIG. 2 shows a graphical visualization of an exemplary vehicle routing problem, in which 3 routes are shown as connected circles, the hashed circles representing pick-up locations and the non-hashed circles representing the drop-off locations;

FIG. 3 shows all 6 combinations (in this case, all permutations) of bookings 1 and 2, each having its pick-up and drop-off, which is used as non-limiting illustration of the method in accordance with various embodiments;

FIG. 4 shows the problem in inserting a booking 9's steps of pick-up and drop-off into a route, in accordance with various embodiments;

FIG. 5 is a schematic representation of a system 400 which may be communication coupled to client's devices 450, 460 to receive bookings 452, 462, and further to drivers and/or vehicles 470, 480, and 490 for providing the vehicle routes; and

FIG. 6 illustrates how bookings 510 may be processed by the method 100 until the vehicle route 550 is generated.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the computer-readable medium, system or methods are analogously valid for the other enclosure computer-readable medium, system or methods. Similarly, embodiments described in the context of a method are analogously valid for a computer-readable medium, system, and vice-versa. Various embodiments relate to vehicle routing technology, the determination of a vehicle route is provided in real time or near real time for a large number of bookings. Such methods cannot be practically performed by the human mind.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

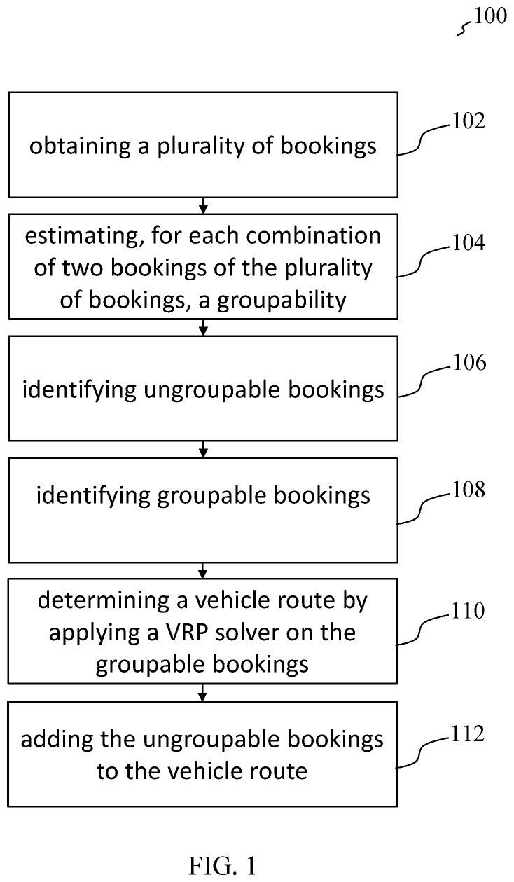

FIG. 1 shows an exemplary and non-limiting flowchart of a method 100 used as illustration to explain embodiments of the present disclosure.

According to various embodiments, the method 100 for generating vehicle routes may include obtaining a plurality of bookings 102, for example via a communication interface such as ethernet. Each booking of the plurality of bookings may include a pick-up and a drop-off location and may be encoded in a data packet. The method 100 may include estimating 104, for each combination of two bookings of the plurality of bookings, a groupability. The estimation may be performed by computer (e.g. in a server or cloud). The estimating 104 of the groupability may include determining a cost ratio of the combination as a ratio of the cost of the combination to the sum of the cost of the two bookings taken separately. A higher groupability may represent a lower cost ratio, and a lower groupability may represent a higher cost ratio. For example, the groupability may be inverse proportional to the cost ratio.

The method 100 may include identifying 106, based on the groupability, all bookings of the plurality of bookings that are not groupable to any other booking of the plurality of bookings, these bookings that are not groupable may be termed ungroupable bookings. The method 100 may include identifying 108, based on the groupability, all bookings that may be groupable to at least one other booking of the plurality of bookings, these bookings that are groupable may be termed groupable bookings. Identifying 106 and identifying 108 may be carried out in reverse order, or at the same time, for example at the same time as 104. Identifying may be performed by the computer, and may be provided within a few milliseconds, e.g., less than 20 milliseconds for a VRP problem with 100 bookings, since it may be performed with simple mathematical computations.

The method 100 may include determining a vehicle route 110 by applying a vehicle routing problem (VRP) solver on the groupable bookings. Since the problem is reduced, a determination of a vehicle route provided in real time or near real time for a large number of bookings is made feasible, which also improves user experience, since a user do not need to wait until a booking request is confirmed and/or a route thereof is confirmed. According to various embodiments, the VRP solver may be configured to determine the vehicle route based on the groupability and/or based on groupable bookings ranked by groupability.

The method 100 may include adding the ungroupable bookings 112 to the determined vehicle route, e.g., as isolated pick-up and drop-off routes.

According to various embodiments, the method 100, may further include generating, for each booking, a cost ranking (also named as ranking of insertion position) based on the cost ratio for each position in the vehicle route, and wherein the VRP solver updates the vehicle route based on the ranking.

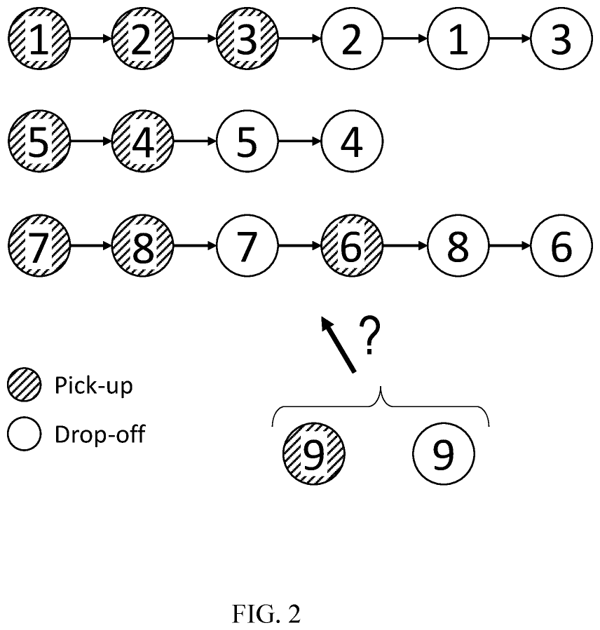

A VRP solver generates a route based on pre-existing routes and/or bookings. For example, a booking has a simple route, which is from its pick-up to its drop-off location. Heuristic algorithms may be adopted for providing VRP solvers that are computationally efficient even for large problems. One common operation in VRP heuristic algorithms is to move bookings' pickup and dropoff step around and try to find a better place for them so that the total cost is reduced. Non-limiting examples of cost are: travel time, travel distance, fuel consumption, road toll, a combination thereof. Different algorithms have their own strategies to determine which bookings to move and where to relocate them to form a new route. FIG. 2 shows a graphical visualization of an exemplary vehicle routing problem, in which 3 routes are shown as connected circles, the hashed circles representing pick-up locations and the non-hashed circles representing the drop-off locations. A new booking 9 including its pick-up and drop-off locations is to be inserted into one of the 3 routes, if feasible. The VRP solver would decide on where to insert booking 9's pickup and dropoff step to the existing routes, so as to achieve the lowest cost increase.

According to various embodiments, a VRP solver may be configured to do an iterative search (referred herein simply as “search”) on possible combinations of pick-up and drop-off locations of bookings.

VRP heuristic algorithms share similar issues when solving large-scale problems. Whenever a step is inserted to a route, it may be needed to validate it against all activated constraints to ensure its feasibility. The worst-case time-complexity is given by (number of constraints*number of steps in a route). As the number of constraints, the complexity of constraints and route length increases, time spent on validating a route increases. This means that given the same amount of time, the VRP solver will explore fewer candidate solutions, reducing the chance of finding high-quality solutions. Due to the combinatorial aspect of the problem, when relocating a step to its best position in the route, the algorithm will need to exhaust every possible position in the routes, along with the necessary feasibility checks. This can significantly slow down the solver. Historical data shows that for some problems, the VRP solver spends time in the relocating step for bookings that end up solo (i.e., ungrouped) due to certain service-level constraints. With the method in accordance with various embodiments, it is possible to identify such bookings beforehand, not only reducing the problem size, but also guiding the VRP solver to explore more promising solutions, for example in a limited time.

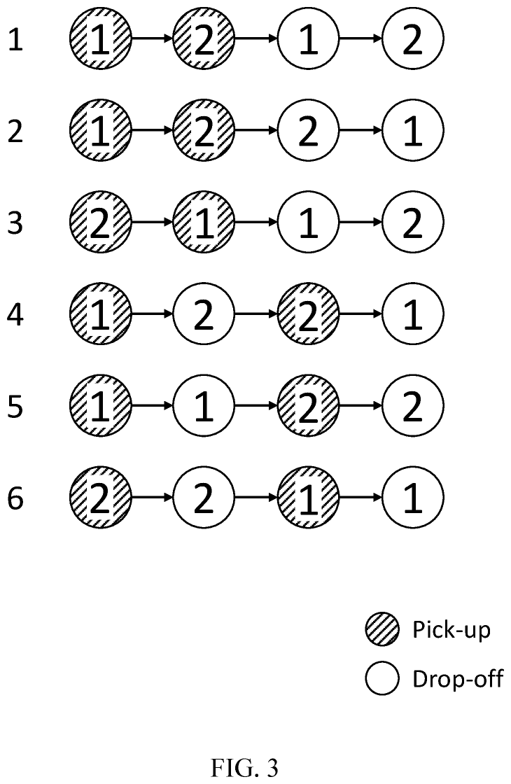

FIG. 3 shows all 6 combinations (in this case, all permutations) of bookings 1 and 2, each having its pick-up and drop-off, which is used as non-limiting illustration of the method in accordance with various embodiments. This small scale example includes two bookings and four pick-up/drop-off points in total.

For each combination (1 to 6) of two bookings (e.g., pair of bookings 1 and 2), the groupability is estimated, by determining a cost ratio of the combination as a ratio of the cost of the combination to the sum of the cost of the two bookings taken separately. For example, the cost ratio (CR) may be determined as

$${CR}_{i} = \frac{{Cost}_{i}}{{Cost}_{1} + {Cost}_{2}} ,$$

wherein the index i is one of the combinations (1 to 6 in the example), Costᵢ is the cost of the combination i, Cost₁ and Cost₂ represent the cost of the bookings 1 and 2 taken separately, respectively. The cost function may be a function of any of: travel time, travel distance, fuel consumption, pick-up location, drop-off location, or a combination thereof. For example, the cost function may be a function of all of travel time, travel distance, fuel consumption, pick-up location, drop-off location. A higher groupability represents a lower cost ratio, and a lower groupability represents a higher cost ratio. For example, the groupability may be defined, in an example as

$$\frac{1}{{LOW}_{i = 1}^{6} ( {CR}_{i} )} \qquad ( Eq . 1 )$$

or a value based thereupon, wherein the function LOW( ) returns the lowest cost ratio of all i combinations. Using Eq. 1, a groupability higher than 1 indicates that grouping bookings 1 and 2 in a combined route is of lower cost than the individual routes, conversely, a groupability smaller than 1 indicates the grouping bookings 1 and 2 in a combined route would increase the costs. In other examples the groupability may be calculated as a function considering all combination costs, weighted by pre-determined factors or unweighted, or a value based thereupon. Other forms of calculation of groupability may be used. For example, in an alternatively, HIGH( ) may be used (e.g. to calculate HIGHᵢ₌₁⁶(CRᵢ)), in two bookings may be considered groupable when the maximum cost ratio among all six combinations is lower than a predetermined sot ratio. Thus, a high cost ratio simply means that when two bookings are grouped in one route, the cost is actually higher than not grouping them, indicating there is much detour. The advantage of this approach is that it is a one-time effort and this information may later be reused in the search process. Other number of bookings (than 2) and thus of permutations may also be used.

According to various embodiments, the method 100 in accordance with various embodiments may further include determining a feasibility of the combination. The combination may be unfeasible if at least one constraint of a plurality of constraints is not met. The combination may be feasible if all constraints of the plurality of constraints may be met. If the combination may be unfeasible, the groupability may be set to represent that the combination is unfeasible. For example, the cost ratio may be very high, e.g., infinite and/or the groupability may be set to a low groupability, for example zero. Alternatively or in addition to encoding the feasibility in the groupability, the determining a vehicle route may ignore the combinations that are marked as unfeasible. In some embodiments, the feasibility is checked before calculating the groupability, and if a combination is marked as unfeasible, it may be ignored when determining the groupability.

According to various embodiments, each of the plurality of bookings may include a pick-up time associated with the pick-up location and a drop-off time associate with the drop-off location. According to various embodiments, determining the feasibility may include determining, for a booking, whether the pick-up time and the drop-off time are possible to be met within a pre-determined time window. If at least one of the pick-up time and the drop-off time are not possible to be met, then the booking is considered unfeasible. According to various embodiments, if the booking is unfeasible, the groupability is set to represent that the combination is unfeasible. Feasibility constraints may include each bookings' pick-p and u drop-off time window (e.g., the driver needs to reach pick-up location (or drop-off location) in a certain time window to ensure service quality), distance between two bookings' drop-off location (e.g., some drivers may prefer to drop-off two bookings close to each other), vehicle capacity constraint specifies the total number of passengers/cargo in two bookings cannot exceed the vehicle capacity.

In some examples, for each pair of bookings, all constraints on the permutations (e.g. above illustrated six permutations 1-6) are checked. If any permutation is feasible and the ratio between route cost and sum of bookings' solo route cost is within certain threshold, these two bookings are said to be highly groupable. After computing the groupability for each pair of bookings, a booking is said to be ungroupable if it cannot be grouped with any other bookings. By removing ungroupable bookings, it is possible to reduce the problem size and let the VRP solver focus on finding optimal routes for groupable bookings. After the solver has determined the vehicle route, the ungroupable bookings may be added to the vehicle route, e.g., at the beginning or at the end.

According to various embodiments, the groupability may be updated during search, in which the VRP solver may generate and/or receive new information when routes are being validated. For example, the groupability between two bookings may decrease when the solver notices that routes are often (e.g., above a pre-determined threshold) infeasible when they are in the same route. AS previously described, the search process may refer to the process of searching for optimal routes. It is an iterative process where candidate route is transformed by changing the order of pick-up and/or drop-off locations according to defined strategies. If this candidate route achieves a lower cost than the best cost found so far, it becomes the new candidate route

According to various embodiments estimated groupabilities including the groupability for each combination of two bookings may be stored in a groupability cache.

According to various embodiments the VRP solver has an allotted time limit to determine the vehicle route. The allotted time limit may be 2 seconds, for example 1 second or 0.5 seconds.

According to various embodiments, the method may be performed within the allotted time lime of 2 seconds, for example 1 second or 0.5 seconds. Thus, preparing the bookings before applying the VRP solver may be done at a very low computation resource cost and high speed, so that, summed with the time required by the VRP solver, there is a net reduction in time required to determine the vehicle route.

Various embodiments envisage a non-transitory computer-readable medium storing computer executable code including instructions for generating vehicle routes as described herein and in accordance with various embodiments.

Various embodiments envisage a computer executable code including instructions for generating vehicle routes as described herein and in accordance with various embodiments.

According to various embodiments, when it is determined whether a booking can be relocated in a route, for example, when the VRP solver tries to relocate (a relocation consists of a removal step, followed by an insertion step) a booking in a route, the method may first check the groupability between this booking and each other booking in the route. If the value is very low for some bookings then it is highly unlikely that this relocation will form a better and feasible route. In such cases, the booking relocation can be skipped completely for the route. A very low groupability may mean lower than a pre-determined groupability threshold of the groupability of a booking against all other bookings in the route. For example, if a booking if has zero groupability with all bookings in a route, the insertion may be skipped.

After it is determined that a booking may be inserted to or relocated in a route, the method may determine a best position to insert the bookings' pick-up and drop-off. A ranking may be implemented, for example, a closeness ranking to represent closeness. Such ranking only needs to be computed once for all bookings and is scale-invariant and more robust to outliers.

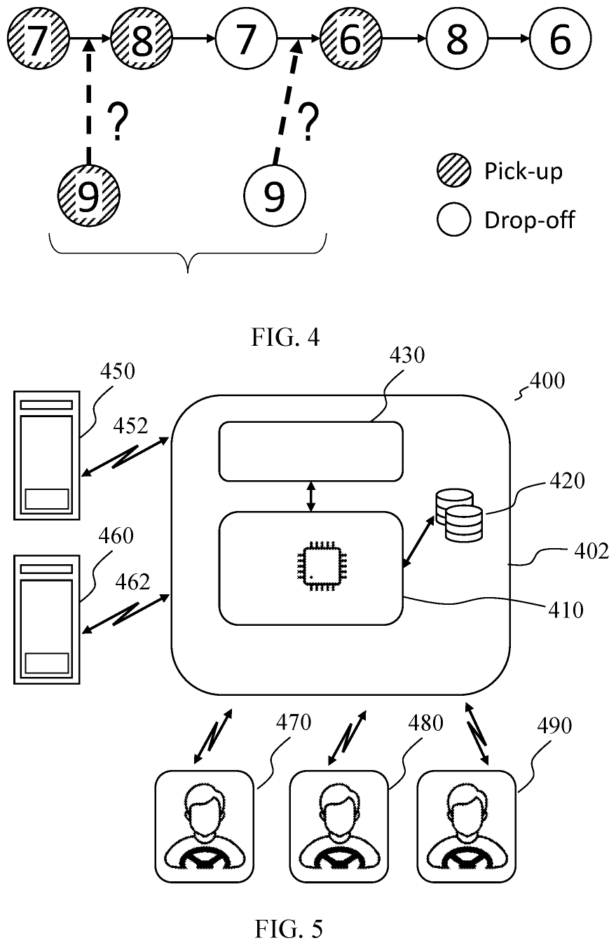

Alternatively or in addition, the method may include to cost rank each step's (pick-up or drop-off) neighboring steps may be based on the cost between them in ascending order. Non-limiting examples of cost are: travel time, travel distance, fuel consumption, road toll, a combination thereof. According to various embodiments, the VRP solver may be further configured to determined suitable insertion places of the booking's steps into the route based on the cost ranking. As illustrated in FIG. 4, In the figure, if pick-up 7 and pick-up 8 have high ranks with pick-up 9, then it is not a promising position, since there are steps closer to pick-up 9, which the VRP solver can try first. The insertion is promising only when the extra cost it introduces is within a certain pre-determined percentage of its solo route cost (i.e., the total cost of two bookings' solo routes). If a booking is added to an existing route and the new route's cost increases significantly, it is unlikely this new route will be optimal. In examples, the pre-determined percentage may be within the range of from 0% to 50% of the total cost of two bookings' solo routes. The exact value may be tuned in accordance to the actual VRP problem. By exploiting the fact that only parts of the route have been changed after inserting steps, it is possible to compute the cost increase in constant time without traversing the whole route.

FIG. 5 is a schematic representation of a system 400 which may be communication coupled to client's devices 450, 460 to receive bookings 452, 462, and further to drivers and/or vehicles 470, 480, and 490 for providing the vehicle routes. According to various embodiments, a data processing system 400 for generating vehicle routes may include a computer 402 including a microprocessor 410 and a memory 420. The memory may be configured to be accessed by the microprocessor 410. The data processing system 400 may include a communication interface 430 configured to obtain a plurality of bookings 452, 462, each booking of the plurality of bookings 452, 462 may include a pick-up and a drop-off location. The communication interface 430 may be included in the computer 402. The computer 402 may be configured to estimate, for each combination of two bookings of the plurality of bookings 452, 462, a groupability by determining a cost ratio of the combination as a ratio of the cost of the combination to the sum of the cost of the two bookings taken separately. A higher groupability represents a lower cost ratio, and a lower groupability represents a higher cost ratio. The computer 402 may be further configured to identify, based on the groupability, all bookings that may be not groupable to any other booking of the plurality of bookings, as ungroupable bookings. The computer 402 may be further configured to identify, based on the groupability, all bookings that may be groupable to at least one other booking of the plurality of bookings, as groupable bookings. The computer 402 may be further configured to determine a vehicle route by applying a vehicle routing problem VRP solver on the groupable bookings. The computer 402 may be further configured to add the ungroupable bookings to the vehicle route. The computer 402 may be further configured to store the vehicle route in the memory 420.

According to various embodiments, the computer 402 may be further configured to generate, for each booking, a cost ranking (also named ranking of insertion position) based on the cost ratio for each position in the vehicle route, and to apply the VRP solver to update the vehicle route based on the ranking.

According to various embodiments, the computer 402 may be further configured to generate, for each booking step (or simple step), a closeness ranking based on the cost for each position in the vehicle route, and to apply the VRP solver to update the vehicle route based on the closeness ranking. Booking comprising steps what are ranked further than a pre-determined closeness threshold by be ignored by the solver (e.g., not input in the solver) and added as separate routes at the end.

According to various embodiments, the computer 402 may be further configured to generate, for each booking step (or simple step), a cost ranking based on the cost for each position in the vehicle route, and to apply the VRP solver to update the vehicle route based on the cost ranking. Booking comprising steps what are ranked further than a pre-determined closeness threshold by be ignored by the solver (e.g., not input in the solver) and added as separate routes at the end.

According to various embodiments the memory 420 may include a groupability cache configured to store estimated groupabilities including the groupability for each combination of two bookings.

According to various embodiments the computer 402 may be configured to determine a feasibility of the combination. The combination may be considered unfeasible if at least one constraint of a plurality of constraints may be not met. The combination may be considered feasible if all constraints of the plurality of constraints may be met. If the combination is unfeasible, the groupability may be set to represent that the combination may be unfeasible. The computer 402 may be further configured to ignore combinations that may be unfeasible when determining a vehicle route.

According to various embodiments the computer 402 may be further configured to limit an allotted time for the VRP to determine the vehicle route.

According to various embodiments the communication interface 430 may be further configured to send the vehicle route to the one or more vehicles or drivers 470, 480, 490.

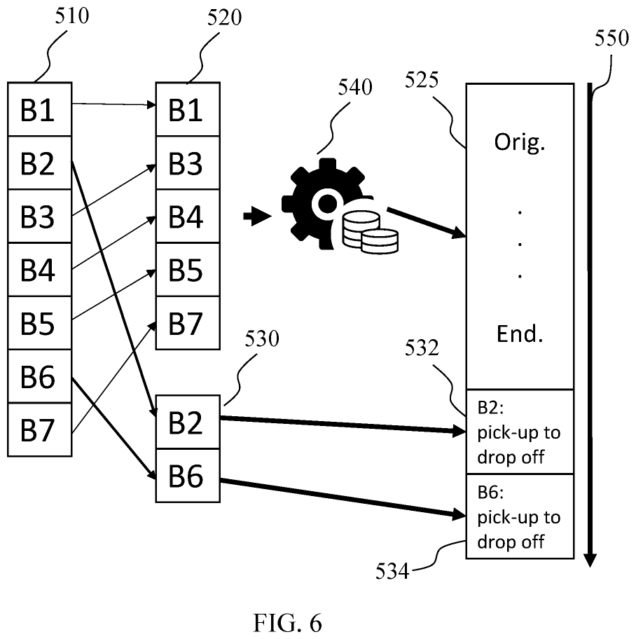

FIG. 6 illustrates how bookings 510 may be processed by the method 100 until the vehicle route 550 is generated. On the left a plurality of bookings 510 is provided, illustrated by B1 to B7. The groupability is estimated for each combination of two bookings of the plurality of bookings, and it is determined that B1, B3, B4, B5, and B7 are groupable (group 520), but B2 and B6 are ungroupable (group 530). The groupable group 520 of bookings may be further ranked. The VRP solver 540 may calculate the vehicle route 525 to which the ungroupable bookings B2 (532) and B6 (534) may be appended. Thus, the resulting route is in the direction 550, starting with subroute 525 from origin to destination, then continuing with pick-up of booking B2 to drop-off of booking B2, and further continuing with pick-up of booking B6 to drop-off of booking B6.

Various embodiments disclose an improvement to VRP solver or VRP solver including the improvement, so that the vehicle routing problem is solvable under real case constrains, such as time constraints and computation resources constraints. Reducing the problem size makes the process or the VRP solver more efficient and faster in terms of computing technology or computing resources.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A computer implemented method for generating vehicle routes comprising
obtaining, a plurality of bookings, each booking of the plurality of bookings comprising a pick-up and a drop-off location;
estimating, for each combination of two bookings of the plurality of bookings a groupability by determining a cost ratio of the combination as a ratio of the cost of the combination to the sum of the cost of the two bookings taken separately, wherein a higher groupability represents a lower cost ratio, and a lower groupability represents a higher cost ratio;
identifying based on the groupability, all bookings that are not groupable to any other booking of the plurality of bookings, as ungroupable bookings;
identifying, based on the groupability, all bookings that are groupable to at least one other booking of the plurality of bookings, as groupable bookings;
determining a vehicle route by applying a vehicle routing problem (VRP) solver on the groupable bookings; and
adding the ungroupable bookings to the vehicle route.

2. The method of claim 1, further comprising generating, for each booking, a cost ranking based on the cost ratio for each position in the vehicle route, and wherein the VRP solver updates the vehicle route based on the ranking.

3. The method of claim 1, wherein estimated groupabilities comprising the groupability for each combination of two bookings are stored in a groupability cache.

4. The method of claim 1, further comprising:
determining a feasibility of the combination, wherein the combination is unfeasible if at least one constraint of a plurality of constraints is not met, and wherein the combination is feasible if all constraints of the plurality of constraints is met;
if the combination is unfeasible, the groupability is set to represent that the combination is unfeasible, wherein
determining a vehicle route ignores combinations that are unfeasible.

5. The method of claim 1, wherein the VRP solver has an allotted time limit to determine the vehicle route.

6. A data processing system for generating vehicle routes comprising
a computer including a microprocessor and a memory, wherein the memory is configured to be accessed by the microprocessor;
a communication interface configured to obtain a plurality of bookings, each booking of the plurality of bookings comprising a pick-up and a drop-off location;
wherein the computer is configured to estimate, for each combination of two bookings of the plurality of bookings, a groupability by determining a cost ratio of the combination as a ratio of the cost of the combination to the sum of the cost of the two bookings taken separately, wherein a higher groupability represents a lower cost ratio, and a lower groupability represents a higher cost ratio;
wherein the computer is further configured to identify, based on the groupability, all bookings that are not groupable to any other booking of the plurality of bookings, as ungroupable bookings;
wherein the computer is further configured to identify, based on the groupability, all bookings that are groupable to at least one other booking of the plurality of bookings, as groupable bookings;
wherein the computer is further configured to determine a vehicle route by applying a vehicle routing problem (VRP) solver on the groupable bookings;
wherein the computer is further configured to add the ungroupable bookings to the vehicle route; and
wherein the computer is further configured to store the vehicle route in the memory.

7. The system of claim 6, wherein the computer is further configured to generate, for each booking, a ranking of insertion position based on the cost ratio for each position in the vehicle route, and to apply the VRP solver to update the vehicle route based on the ranking.

8. The system of claim 6, wherein the memory comprises a groupability cache configured to store estimated groupabilities comprising the groupability for each combination of two bookings.

9. The system of claim 6, wherein the computer is configured to
determine a feasibility of the combination, wherein the combination is unfeasible if at least one constraint of a plurality of constraints is not met, and wherein the combination is feasible if all constraints of the plurality of constraints is met;
and if the combination is unfeasible, the groupability is set to represent that the combination is unfeasible, and
wherein the computer is further configured to ignore combinations that are unfeasible when determining a vehicle route.

10. The system of claim 6, wherein the computer is further configured to limit an allotted time for the VRP to determine the vehicle route.

11. The system of claim 6, wherein the communication interface is further configured to send the vehicle route to the one or more vehicles or drivers.

12. A non-transitory computer-readable medium comprising instructions which, when the instructions are executed by a computer, cause the computer to carry out a method for generating vehicle routes, the method comprising:
obtaining, a plurality of bookings, each booking of the plurality of bookings comprising a pick-up and a drop-off location;
estimating, for each combination of two bookings of the plurality of bookings, a groupability by determining a cost ratio of the combination as a ratio of the cost of the combination to the sum of the cost of the two bookings taken separately, wherein a higher groupability represents a lower cost ratio, and a lower groupability represents a higher cost ratio;
identifying, based on the groupability, all bookings that are not groupable to any other booking of the plurality of bookings, as ungroupable bookings;
identifying, based on the groupability, all bookings that are groupable to at least one other booking of the plurality of bookings, as groupable bookings;
determining a vehicle route by applying a vehicle routing problem (VRP) solver on the groupable bookings; and
adding the ungroupable bookings to the vehicle route.

13. (canceled)
